(19) United States
(12) Patent Application Publication
(10) Pub. No.: US 2022/0204223 A1
(43) Pub. Date: Jun. 30, 2022

(54) LID WITH A FASTENING MECHANISM FOR TIGHTENING A LID SKIRT AROUND A SIDEWALL OF A PAIL AND A PAIL FOR SAID LID AND A THERMALLY INSULATED COMPOUND PAIL

(71) Applicant: Lidtek AS, Oslo (NO)

(72) Inventor: Rodney Omdal Karlsen, Oslo (NO)

(73) Assignee: Lidtek As, Oslo (NO)

(21) Appl. No.: 17/611,286

(22) PCT Filed: May 18, 2020
(86) PCT No.: PCT/NO2020/050125

§ 371 Date: Nov. 15, 2021

(30) Foreign Application Priority Data
May 16, 2019 (GB) 1906945.9
May 16, 2019 (NO) 20190625

(51) Int. Cl. B65D 43/02; B65D 25/32

(52) U.S. Cl. CPC B65D 43/0212; B44D 3/127; B65D 25/32

(57) ABSTRACT

It is desired to make an improved lid suitable for pails, overcoming the problem of existing complexities and leaks. The invention is achieved by a lid (300) having a lid skirt (320) provided with an inner collar (328) that engages an outer collar (222) of a sidewall (220) of a pail (200), the lid skirt (320) being provided with a fastening mechanism (330) for tightening the inner collar (328) around the sidewall (220) below the outer collar (222). Corresponding to the lid (300) a pail (200) is provided having a simplified structure that is supported mechanically by the lid (300). Furthermore, a thermally insulated compound pail is disclosed, the compound pail comprising a first inner pail (200) that is inserted into a second outer pail (200) such that a space (404) is formed between said pails (200).

### BACKGROUND OF THE INVENTION

### Field of the Invention

The invention relates to lids in general and more specifically a lid for paint pails, and a pail for use with lid.

### Background Art

State of the art is reflected in traditional metal lids for metal paint pails where the lid is pressed down into an opening where a conical surface of the lid engages a lip formed around the opening of the pail. Plastic lids for plastic pails are also know, where a peripheral part of the lid engages the outer periphery of the pail. Such lids are hard to remove and typically requires external tools such as screwdriver and knife. Even when using tools there is a risk that a kink is formed in either the lid or the rim, that makes replacement or proper sealing difficult, without spilling of the contents. In any case closing the lid requires strong force. Pails are typically provided with simple handles that add complexities and also reduce package densities when storing, stacking and transporting pails.

GB2561576 discloses a lid with a skirt that engages the outer periphery of a can, wherein the lid is further provided with a clamp that locks the lid in place. The lid is provided with a valve to permit attachment of a pump for creating a partial vacuum. The problem is to ensure tight fitting and a good sealing. No information on handles is provided.

US2004/0238544 discloses a device for sealing paint in a can to preserve the paint. The problem is that this device is difficult to insert and remove and to ensure the seal is airtight. The can shown is of a traditional type with a traditional handle.

U.S. Pat. No. 3,499,574 discloses a resilient closure having retaining means.
GB 2561576 discloses a vacuum container with means to extract air and seal lid.
U.S. Pat. No. 2,772,907 discloses a toggle-operated closure fastener.
WO 2005/051792 disclose a reusable closure with a locking ring for a container.
GB 1338336 disclose a lid locking device for containers having a relatively large aperture.
U.S. Pat. No. 5,284,270 disclose a lever latch ring for securing a cover panel to a container.
DE 102012109559 disclose a closure for a container having a circumferential edge.
GB 2101103 disclose a container lid.
DE 602004000422 disclose food container.

There is therefore a need for a method and a system to overcome the above-mentioned problems.

### SUMMARY OF THE INVENTION

### Problems to be Solved by the Invention

Therefore, a main objective of the present invention is to provide a lid that ensures good sealing and also permits good stacking density. It is also an objective of the present invention to provide a pail suited for the lid according to embodiments of the invention that ensured high packing density.

### Means for Solving the Problems

The objective is achieved according to the invention by a lid as defined in the preamble of claim 1, having the features of the characterising portion of claim 1, and by a pail as defined in the preamble of claim 13, having the features of the characterising portion of claim 13, and by a thermally insulated compound pail as defined in the preamble of claim 17, having the features of the characterising portion of claim 17.

A number of non-exhaustive embodiments, variants or alternatives of the invention are defined by the dependent claims.

The present invention attains the above-described objective by a lid having a lid skirt provided with an inner collar of the skirt, for engaging below an outer collar of the sidewall of a pail, and a fastening mechanism for tightening the lid skirt around the sidewall.

In a first aspect a lid for a pail is provided, wherein the pail comprises a base forming the bottom surface of the pail, a sidewall of the pail, wherein sidewall is further provided with an outer collar provided distal to the base, wherein the collar extends radially outward from the sidewall, and an upper part, wherein the lid comprises a lid body further comprising a lid skirt extending down from the lid body, wherein the lid skirt is provided with an inner collar of the skirt, for engaging below the outer collar of the sidewall, and a fastening mechanism for tightening the lid skirt around the sidewall.

In a preferred embodiment the skirt is sub divided into a plurality of tongues separated by a plurality of skirt incisions. This provides flexibility and also saves weight and material cost.

In a preferred embodiment the fastening mechanism is the plurality of tongues provided with spring action that form an inner collar that will grip the pail by the collar when the tongues are in a relaxed state.

In a preferred embodiment the tongues are further provided with a canal for a wire that encompasses the tongues and end in a fastening mechanism. This allows for stronger and more secure attachment.

In a preferred embodiment the fastening mechanism comprises a tightening wheel that winds up the wire on a spool, pressing the tongues together.

In a more preferred embodiment the tightening mechanism is provided with a ratchet mechanism that is arranged to be released using a release mechanism for opening and detaching the lid.

In a preferred embodiment the fastening mechanism comprises a spring that tension the wire, pressing the tongues together. This permits pre-tensioning the attachment yet with enough spring action to fore the lid over a pail to engage the pail without damaging the lid in the process.

In a preferred embodiment the lid is provided with at least one seal, for the pail further wherein the upper part further comprises an outer rim that is a raised extension of the sidewall, and a downward extending part that connect to an inner rim rising up from the intervening downward extending part, wherein inner rim encloses an opening to the interior of the pail.

In a preferred embodiment the lid is provided with an inner seal that engages the inner rim of the pail.

In a preferred embodiment the lid is provided with an outer seal that engages the outer rim of the pail.

In a preferred embodiment the lid further comprises an air extractor provided on the top of the lid, extracting air from the inside of the pail through a valve. This improve storage life of the contents also after the lid has been opened.

In a preferred embodiment the lid is provided with a lid handle.

In a preferred embodiment the lid body is provided with a stacking collar having a width adapted to receive the base of another pail.

In a second aspect a pail for a lid is provided, wherein the pail comprises a base forming the bottom surface of the pail, a sidewall of the pail, wherein sidewall is further provided with an outer collar provided distal to the base, wherein the collar extends radially outward from the sidewall, and an upper part comprising a rim extending from the sidewall.

In a preferred embodiment the sidewall is provided with a conical structure, wherein the rim has an inner diameter large enough to receive the bottom surface of a pail.

In a preferred embodiment the outer collar is positioned on the sidewall so that when stacked on a second pail the rim of the second pail engages the outer collar of the pail, thus preventing the sidewalls from engaging.

In a preferred embodiment wherein the pail further comprises a rim handle assembly provided on the rim, wherein the rim handle assembly comprises a rim handle attached to rim handle attachments placed on the rim. This allows for a compact solution while retaining a handle.

In a third aspect a thermally insulated compound pail is provided, comprising a first inner pail inserted into a second outer pail, wherein the first inner and second outer pails comprise a base forming the bottom surface of the pail, a sidewall of the pail, wherein sidewall is further provided with an outer collar provided distal to the base, wherein the collar extends radially outward from the sidewall, and an upper part comprising a rim extending from the sidewall, wherein a space is formed between the first inner and second outer pails.

In a preferred embodiment the thermally insulated compound pail further comprises an interposer positioned between the upper parts of the first inner and second outer pails, thereby opening up a volume between the sidewalls of the pails, extending the space to this volume.

In a more preferred embodiment the thermally insulated compound pail further comprises insulation in at least parts of the space.

In a fourth aspect a lid for a pail is provided, wherein the lid comprises a lid body with a peripheral skirt having an inner collar which in use engages with a collar on a pail to secure the lid to the pail.

In a fifth aspect a pail is provided, wherein the pail further comprises a sidewall defining an opening with a collar and a rim extending therefrom, the rim in use receiving a lid with a corresponding collar to close the opening.

In a preferred embodiment the pail further comprises a sidewall with an outer collar defining an opening, a lid with an inner collar engageable with the outer collar and a securing mechanism that tightens the inner collar around the sidewall below the outer collar.

### Effects of the Invention

The present invention comprises a technological advantage over known systems and methods by use of collars on the skirt and the pail engaging to provide mechanical strength.

The lid according to the present invention provides several further advantageous effects:
it makes it possible to lift the pail using the lid,
it makes it easy to further provide the lid with air extraction means to keep the contents fresh,
it makes it possible to use a simplified pail.

The pail according to the present invention provides several further advantageous effects:
it makes it possible to simplify the design of the pail and avoid multiple rims in the upper part of the rim,
it allows for use of less materials,
it allows for efficient stacking of empty pails,
it reduces production cost, and
it allows for efficient stacking of empty pails.

### BRIEF DESCRIPTION OF THE DRAWINGS

The above and further features of the invention are set forth with particularity in the appended claims and together with advantages thereof will become clearer from consideration of the following detailed description of an [exemplary] embodiment of the invention given with reference to the accompanying drawings.

The invention will be further described below in connection with exemplary embodiments which are schematically shown in the drawings, wherein:

FIG. 1 shows a pail with lid attached,

FIG. 2A shows a cross section of a pail with lid attached,

FIG. 2B shows a detailed view of the cross section of a pail with lid attached,

FIG. 3 shows a lid from below,

FIG. 4A shows a detailed view of the closing and release mechanism for the lid,

FIG. 4B shows a cross section view of the closing and release mechanism for the lid shown in FIG. 4A,

FIGS. 4B, 4C and 4D show variations of a closing mechanism,

FIG. 5 shows pails stacked on top of each other,

FIGS. 6A-E show a pail according to an embodiment of the invention,

FIGS. 6F-H show pails according to FIGS. 6A-E stacked into each other,

FIGS. 7A-B show a pail according to an embodiment of the invention having an inner rim,

FIGS. 7C-E show pails according to FIGS. 7A-B stacked into each other,

FIG. 8 shows a conical pail with lid attached,

FIGS. 9A-E show embodiments of rim handles, and

FIGS. 10A and 10B shows a thermally insulated pail.

### DESCRIPTION OF THE REFERENCE SIGNS

The following reference numbers and signs refer to the drawings:

| | |
|---|---|
| 100 | The system, a pail closed with a lid |
| 200 | Pail |
| 210 | Base, bottom surface of pail |
| 220 | Sidewall of pail |
| 222 | Outer collar of sidewall |
| 230 | Handle assembly |
| 232 | Handle, bail |
| 234 | Handle attachment, ears |
| 240 | Upper part of pail |
| 242 | Inner rim |
| 244 | Outer rim |
| 248 | Opening |
| 250 | Rim handle assembly |
| 252 | Rim handle, rim bail |
| 254 | Rim handle attachment, rim ears |
| 300 | Lid |
| 310 | Lid body |
| 312 | Inner seal |
| 314 | Outer seal |
| 316 | Lid handle |
| 318 | Stacking collar |
| 320 | Lid skirt |
| 322 | Skirt tongue |
| 324 | Skirt incision |
| 326 | Canal for wire |
| 328 | Inner collar of skirt |
| 330 | Fastening mechanism |
| 332 | Tightening wheel |
| 333 | Ratchet mechanism |
| 334 | Release button |
| 335 | Release mechanism |
| 336 | Wire winding spool |
| 337 | Wire |
| 338 | Spring |
| 340 | Air extractor |
| 342 | Pump bellow |
| 344 | Valve |
| 402 | Spacer, interposer |
| 404 | Space |
| 406 | Insulation |

### DETAILED DESCRIPTION OF THE INVENTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

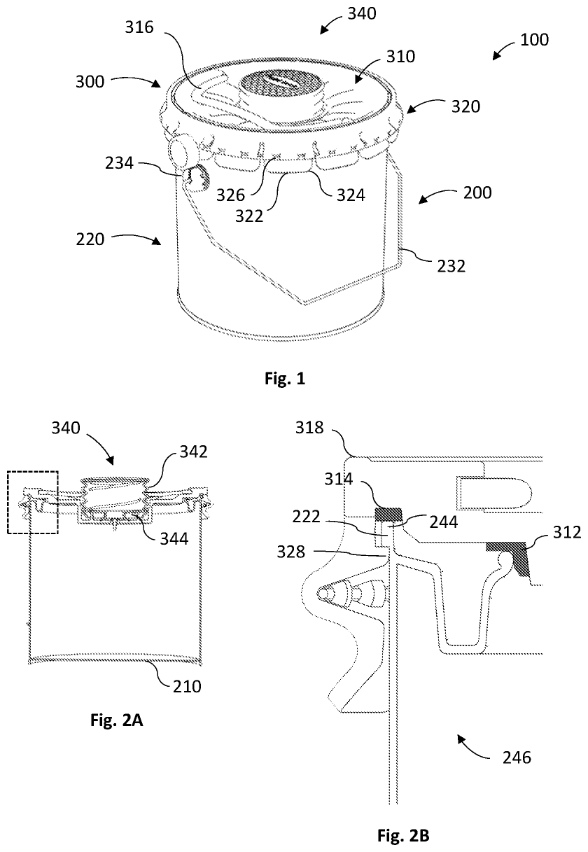

The invention will be further described in connection with exemplary embodiments which are schematically shown in the drawings, wherein FIG. 1 shows a pail with lid attached.

Principles Forming the Basis of the Invention

The inventor has realised that traditional pails are provided with features that can be used with an improved lid to provide improved attachment and convenience. A pail 200 comprises a base 210 forming the bottom surface of the pail, sidewall 220 of the pail that typically is cylindrical, and an upper part 240. Typically the sidewalls are provided with a handle assembly 230 comprising a handle or bail 232 that is attached to a handle attachment or ear 234 placed on opposite sides of the sidewall 220.

Standard metal pails 200 for paint are provided with a trapezoidal upper part 240. This further comprises an outer rim 244 that is a raised extension of the sidewall 240, and a downward extending part that connect to an inner rim 242 rising up from the intervening downward extending part. This inner rim encloses an opening 248 to the interior of the pail. It is this opening that is closed by a traditional lid.

The sidewall 220 is also provided with an outer collar 222 provided near the upper part 240, wherein the collar extends radially outward from the sidewall.

The lid 300 comprises a lid body 310, which is provided with a skirt 320 for engaging with the sidewall 220 of the pail 200, the skirt being provided with an inner collar 328 that engages below an outer collar of the sidewall. A fastening mechanism is used to tighten the skirt around the sidewall and thus secure a fit between the inner and outer collars. This results in sufficient holding strength to lift the pail by the lid. The fastening mechanism can be inherent in the skirt or a mechanism to tighten the skirt.

The inventor has realised that the lid of the present invention will provide sufficient structural strength to the system 100 comprising a pail with a lid, making it possible to forego strengthening structural features at the upper part 240 of the pail. Such features include the trapezoidal structures comprising the inner rim 242. This trapezoidal part is typically made as a separate part, pressed to shape and attached to the sidewall 220 of the pail. Experience shows that this attachment is not always leak proof.

When attacking a lit to a pail, the lid can simply be slid over the outer collar until the inner collar 328 of the skirt slips over and down past the outer collar 222 of the sidewall. At this point the skirt grips the pail by the collar. Tightening of the skirt around the collar can be achieved by springiness in the skirt, a tightening mechanism using a wire tensioned by a fastening mechanism and/or a spring.

If the skirt in the relaxed state does not grip the pail by the collar a tightening mechanism must be engaged to attach the lid and sufficiently released to detach according to the procedure above.

Detaching the lid is the reverse process of the above. If present, the wire tension is released. Next the lid is loosened from the lid by pulling the skirt outwards until at least parts of the inner collar 328 of the skirt slips up and past the outer collar 222 of the sidewall. At this point the rest of the skirt is easily detachable from the pail.

### BEST MODES OF CARRYING OUT THE INVENTION

The embodiment of the apparatus according to the invention shown in FIGS. 1 and 2A showing a completed system 100, a pail 200 closed with a lid 300.

It is preferred that the inner collar of the skirt has a profile that provides a larger diameter at the lower end, tapering to a narrower diameter at an upper end. This provides easy means to pull the lid down over the pail and also a wide ledge at the top, engaging a large part of the underside of the outer collar of the sidewall.

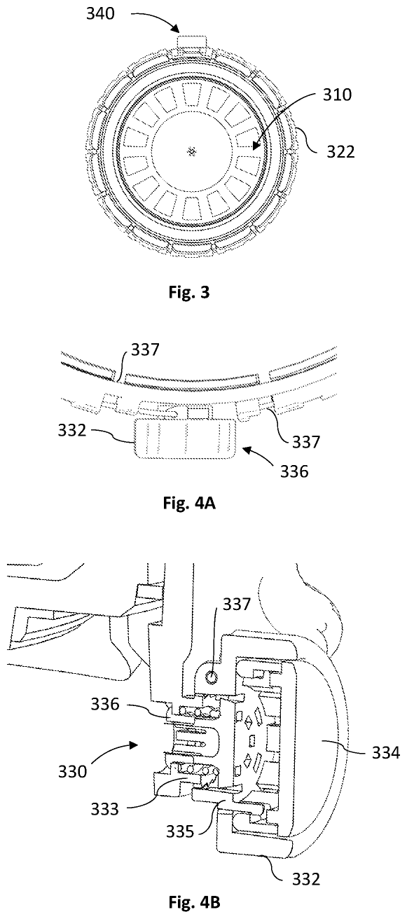

FIG. 3 shows a lid from below, showing a preferred embodiment wherein the skirt 320 is sub divided into a plurality of tongues 322 separated by a plurality of skirt incisions 324. This allows the intrinsic elastic deformability of the material to flex the tongues inwards so to engage the outer collar of the pail with inner collar sections provided on the tongues. This way the lid can be made of a uniform material for both the lid body and the lid skirt, simplifying the manufacturing process.

The flexing can take place at the upper end of the tongues where the incisions end, by making the tongues narrower in a constriction. The tongues can be made narrower in width or depth, or a combination of the two. The use of tongues also mean that the inner collar 328 is split between the tongues.

It is preferred that the tongues have a natural spring action that allows the lid to be pushed over a pail and the fingers snap in under the outer collar of the pail and thus is attached to the pail, closing it. Especially if there is no other fastening mechanism, this is preferred.

It is preferred that the tongues in their relaxed state provide an opening that allow the lid to be easily removed from the pail without having to force the tongues out by hand in order to release the lid, especially when the lid is provided with a fastening mechanism for the tongues. Preferably, the tongues should not have to move more than the material of the lid will allow without inducing fatigue. It is preferred to stay within the limits of elastic deformation. This way a plastic material can be used as an alternative to metal.

It is also preferred that the tongues flare outwards at the lower end. This allows easier fitting to pails and also allows good attachment for fingers when detaching the lid. It also provides extra tolerance for lids attached by machines such as for instance in paint production.

The skirt incisions 324 are preferably narrow to allow for wide effective inner collar length. The incisions are preferably terminated with a rounded feature at prevent crack propagations. In the case of providing tongues with extended flexibility using a constriction, this can be combined with an extended rounded terminating feature of the incision.

The system is provided with means for tightening the tongues against the sidewall. Preferably, the tongues are further provided with a canal 326 for a wire that encompasses the tongues and end in a fastening mechanism 330.

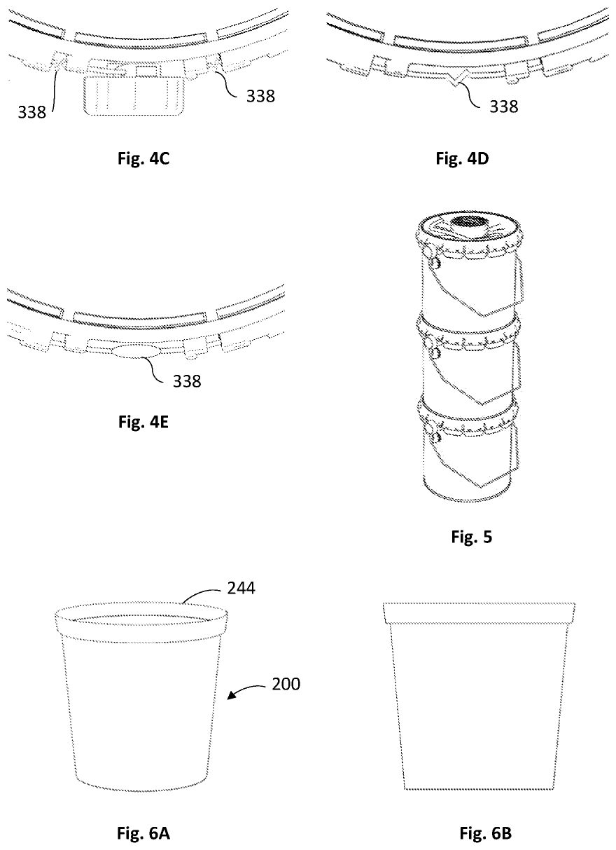

FIG. 4A shows a detailed view of the closing and release mechanism for the lid. Typically, this is a tightening wheel 332 that winds up the wire on a wire winding spool 336, pressing the tongues together. Preferably, the tightening mechanism is provided with a ratchet mechanism 333 that can be released using a release mechanism 335 for opening and detaching the lid. The release mechanism is preferably activated a button 334, more preferably set inside the fastening mechanism to protect the button from being accidentally pressed.

FIG. 4B shows a cross section view of the closing and release mechanism for the lid shown in FIG. 4A. Inside is a ratchet mechanism that prevents the wire winding spool from unwinding, while permitting the tightening wheel 332 to tighten the wire winding spool. A button 334 is positioned inside the wheel 332 and when pressed, the button disengages the ratchet mechanism 333.

To preserve the contents of the pail, it is desirable to provide tight sealing between the lid and the pail. The inventor has realised that pails are used in rough environments and it is thus strongly preferable that seals will work also on damaged pails.

FIG. 2B shows a detailed cross section view of a lid attached to a pail, wherein the lid is provided with at least one seal. On one embodiment, the lid is provided with an inner seal 312 that engages the inner rim 242 of the pail. In a second embodiment, the lid is provided with an outer seal 314 that engages the outer rim 244 of the pail. In a third embodiment, shown here, the lid is provided with both the inner and the outer seal.

The seals can have various structures. In one embodiment, the seal is a resilient material provided as a ring in a recessed space or a slot. This is shown in FIGS. 2 and 3 for the outer seal 314, and provides a secure and protected area for the outer rim 244 to enter. The recessed structure protects the structure of the pail and permits larger loading strength than without such structure. This is based on the principle of the strength of a cylinder, noting that with a slight kink the cylinder will lose its strength. Thus this embodiment provides extra strength both for transport as well as for when in use.

In a different embodiment, the seal is a resilient material provided as a ring having a raised portion, forming an angle in cross section. This is shown in FIGS. 2A and 2B for the inner seal 312, and provides a secure sealing action for the inner rim 244 to engage. This also takes advantage of the flexing properties of the trapezoidal structure.

The preservative properties can be further improved by means for evacuating air from the pail. An air extractor 340 is preferably provided in the form of a pump bellow 342 on the top of the lid, extracting air from the inside of the pail through a valve 344.

When sufficient amounts of air has been evacuated, the bellows stay down, indicating the air extraction is complete.

The under pressure in the pail is maintained by the at least one seal and also contribute to the vertical lifting capacity of the lid.

In a preferred embodiment, the lid is provided with a lid handle. More preferably, the handle fits into a recess in the lid body when not in use.

In a further preferred embodiment the lid body 310 is provided with a stacking collar 318 having a width adapted to receive the base 210 of another pail.

FIG. 1 shows a pail according to an embodiment of the invention, wherein the pail 200 for use with the lid 300, the pail comprises a base 210 forming the bottom surface of the pail, sidewall 220 of the pail that typically is cylindrical, and an upper part 240 that comprises a rim 244 extending from the sidewall 220. The sidewall 220 is also provided with an outer collar 222 provided near the upper part 240, wherein the collar extends radially outward from the sidewall.

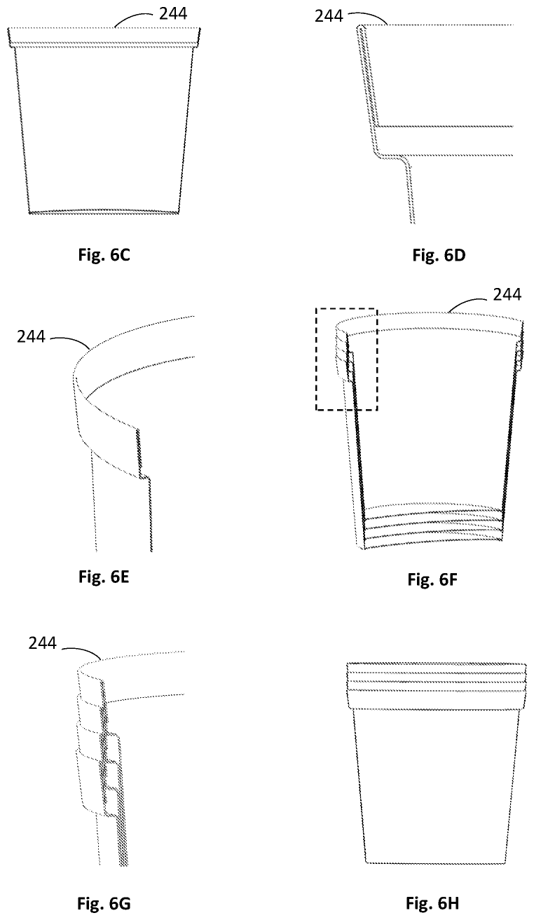

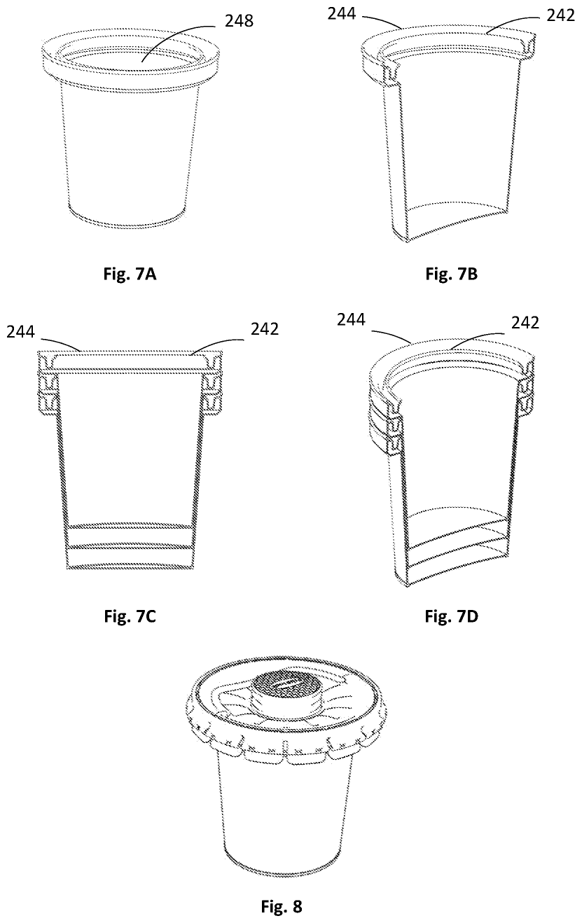

FIGS. 6A-6F shows stacked pails according to an embodiment of the invention wherein the sidewall is slightly conical. This allows stacking pails far denser than with traditional metal pails with trapezoidal upper parts. In a preferred embodiment the rim 244 of a lower pail engages with the outer rim of an upper pail in a stack, so that there is a little clearance between the pails. This avoids pails sticking to each other due to thermal expansion and contraction.

FIGS. 6A-E show a pail according to an embodiment of the invention, in perspective, side view, cross section, detailed cross section and detailed perspective respectively. Preferably the end of the sidewall is folded down to avoid sharp edges as well as provide extra strengthening of the collar. This is shown in FIG. 6D which is a detail of FIG. 6D and shown in perspective in FIG. 6E.

FIGS. 6F-H show pails according to FIGS. 6A-E stacked into each other, in cross section, detail of the cross section, and side view respectively. The coning angles of the sidewall and the collar are chosen to match for stacking, as shown in FIG. 6G.

FIG. 8 shows a conical pail with lid attached.

### Alternative Embodiments

A number of variations on the above can be envisaged. For instance, the skirt can be made of a resilient material as an alternative to using tongues and incisions in the skirt.

It should also be noted that incisions in this context does is not restricted to mean a gap is formed to make the skirt discontinuous. In a variation also within the scope the incision can be formed by a fluted structure or by pleating or any similar structure that provides sufficient freedom of movement for the tongues, which is the primary purpose of subdividing the skirt into tongues.

As an alternative to the inner collar on tongues, the wire itself can be used to grip the outer rim of the pail. In such an embodiment the tongues do not need the same amount of flexibility. The inner collar must be understood broadly as a means for engaging the outer collar of the rim to provide attachment.

For large scale operations such as filling pails with pain and sealing with lids, it is preferred to keep this process as simple as possible. Instead of placing the lid and tightening the fastening mechanism in two steps, the wire 336 can be provided with a spring 338 or the wire can be made of an elastic material. Lids can be provided pre-tensioned and pressed onto the pails wherein the spring action will let the inner collar of the lid slide outwards and down over the outer collar of the pail, snapping into position and securing the contents.

FIGS. 4B, 4C and 4D show such variations of a closing mechanism. In FIG. 4C the wide 337 is provided with a spring 338 as part of the wire itself, shown to the left, or at the end attachment of the wire shown to the right. It is possible to provide springs in more than one location.

FIG. 4D shows an embodiment without a wheel and with a spring. FIG. 4D shows the same as in FIG. 4D where the spring is replaced by am elastic material, such as rubber.

As an alternative to the tightening mechanism shown, the handle can be used. By connecting the wire to the handle the action of raising the handle, for instance from a recessed position, can be used to tighten the wire. Thus the user can be assured that the simple act of holding the pail by the handle in the lid will have secured the tightening. A ratchet mechanism will ensure the lid remains secured. Also the handle can be used to engage the release mechanism, for instance by pressing the handle down into its recessed position.

The embodiments shown employ a release mechanism 334 in the form of a button to be pushed. This button can be replaced with a pull mechanism, thus improving packing densities of sets of pails and further avoid accidental lid releases.

The pump bellow 342 can be made optional and replaceable. Thus in one embodiment the air extractor comprises the valve 344 as before and an attachment on top of the lid. In production, air can be extracted from the pail after lid has been placed in position, improving storage quality. The user is able to attach a pump bellow 342 if needed.

It should be noted that the air extractor 340 is not restricted to air alone but also other gases and fumes, such as solvent fumes used in production of paint. The extracted fumes can be extracted and collected for disposal or condensed for reuse.

The fastening mechanism having a fastening wheel has been found to provide an inner volume enclosed by the wheel and the button, wherein this inner volume can be used for added functionality relating to fastening and opening. In one embodiment the button can be clear, covering a mechanical counter that indicates how many times the opening mechanism has been used, thus also being able to assure a buyer that the lid has not been opened before without the need for further sealing.

In an alternative embodiment the fastening mechanism comprises a display, behind or as part of the button face, that indicates a status. For instance a green light from a LED can indicated time to take a medicine, an amber light can indicate the contents is not made available, and a red light can indicate the contents of the pail is past an expiry date. The button can be illuminated to indicate an action has to take place such as use the contents, and then extinguish on pushing the button. The button can further be provided with a chip for further intelligence and communications with an app for uploading data such as a log of usage, and download programming or schedules for indication and locking functions for the button to follow.

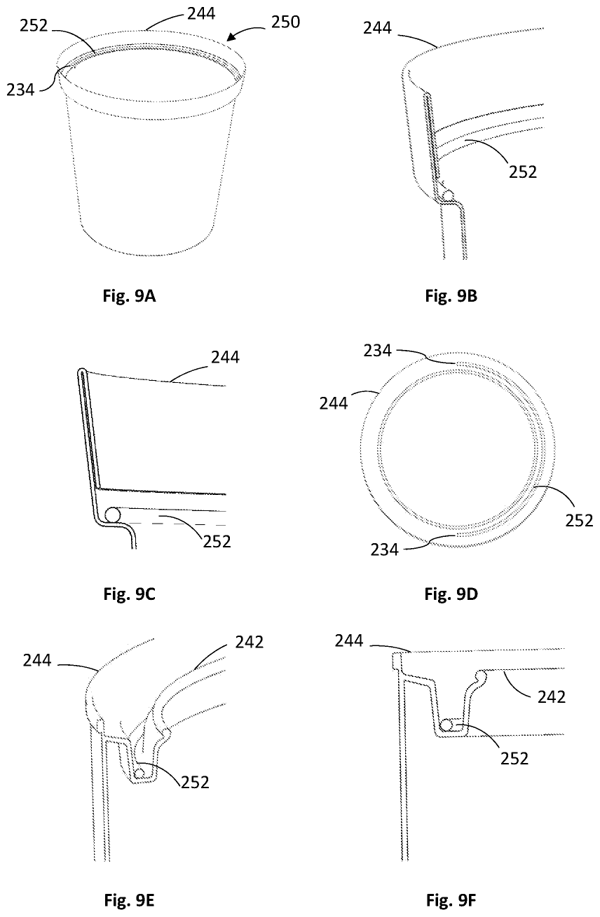

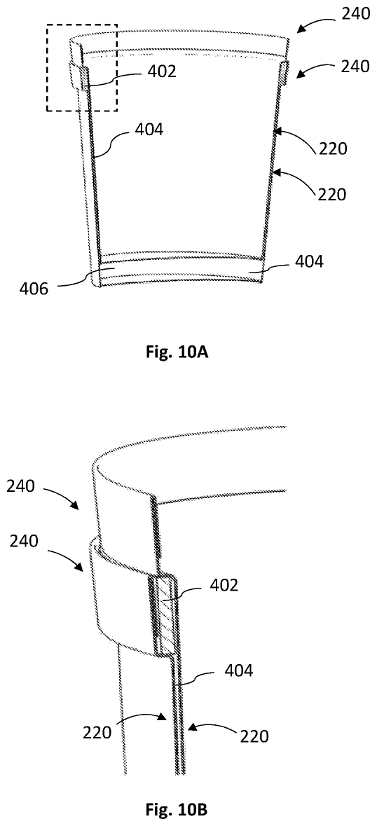

FIGS. 9A-E show embodiments of rim handles. For maximum density stacking, it is preferred to eliminate the traditional handle assembly 230 since the ears 234 protrude outwards from the sidewall 220.

FIG. 9A shows a pail in perspective, having an outer rim only. A rim handle assembly 250 comprising a rim handle or rim bail 252 that is attached to rim handle attachments or rim ears 234 placed on opposite sides inside the outer rim 244. FIGS. 9B and 9C show a detailed section view of the rim handle folded down along the inner surface of the outer rim 244. FIG. 9D shows a top view, where the rim handle 252 is fully enclosed by the outer rim 244. Such an arrangement is useful for dry goods. For wet contents such as paint the bail is preferably protected from contact with the contents.

FIG. 9E shows a detailed view in perspective of a pail where a rim handle 252 positioned in the space formed between an inner rim 242 and an outer rim 244. FIG. 9F shows this in a side view. In this embodiment the rim handle is protected from contact with the contents since the inner rim 252 is brought in contact with the inner seal 312 when the lid is placed on the pail.

As an alternative a handle can be formed on the rim 244. A rim handle assembly 250 comprising a rim handle or rim bail 252 that is attached to rim handle attachments or rim ears 234 placed on opposite sides of the rim 244. When not in use the handle preferably folds down flush along one half of the rim 244, and is protected from the contents by the seal 314.

In one embodiment the ability to stack pails have been further exploited to form a thermally insulated compound pail comprising a first inner pail and a second outer pail, enclosing a space 404. The space can be air, be filled with thermal insulation 406 or filled with a phase transition medium such as water. Water has a large heat capacity which in itself will protect the contents. As the temperature drops, water undergoes a phase transition to ice and thus releases latent heat that can protect the contents. Correspondingly if the purpose is to maintain low temperature the space can be filled with a cooling medium such as ice or dry ice.

In a beneficial embodiment the inner and outer pail are identical. This ensures that the pails are easy to stack and also simplifies logistics in that a single line of pails can be used for both inner and outer pail.

Such an embodiment provides good insulation at the base 210 of the pail but less insulation at the sidewalls 220.

FIG. 10A shows a second embodiment this is overcome using an interposer 402 between the upper parts 240 of the two pails. By effectively raising the upper inner pail a volume opens up between the sidewalls 220 of the pails, extending the space 404 to this sidewall space. also this extended space can be filled, in full or partially, with air, insulation or a phase transition medium. FIG. 10B shows this embodiment in detail, where the sidewall space is more clearly shown. In a more preferred embodiment the interposer 402 comprises a spacer that prevents the sidewalls of the pails from coming into contact with each other. This can take on many forms such as a ring in the area between the sidewalls or fingers, preferably 3 fingers that extend from the interposer and down into the area between the sidewalls.

Such compound pails also have the advantage of providing improved mechanical protection, in that the second outer pail absorbs mechanical deformation without breaking the inner pail. A deformable insulating material between the sidewalls can further improve mechanical protection in that a concentrated impact on the outer pail with be distributed over a wider area of the inner pail, thus preventing or limiting deformation or breakage. Also a deformable or resilient interposer 402 will improve the overall mechanical strength, especially if the compound pail is dropped. In such cases much of the impact is absorbed by the interposed before the outer pail is deformed, both of which protect the inner pail, avoiding breakage.

### INDUSTRIAL APPLICABILITY

The invention according to the application finds use in sealing contents in pails, especially paint.

1. A lid for a pail,
wherein the pail comprises:
a base forming the bottom surface of the pail,
a sidewall of the pail, wherein sidewall is further provided with an outer collar provided distal to the base, wherein the collar extends radially outward from an upper part of the sidewall, and
wherein the lid comprises a lid body further comprising a lid skirt extending peripherally from the lid body,
characterised in that the lid skirt is provided with an inner collar of the skirt, for engaging below the outer collar of the sidewall, and
a fastening mechanism for tightening the lid skirt around the sidewall.

2. The lid according to claim 1, wherein the inner collar of the skirt is sub divided into a plurality of tongues separated by a plurality of skirt incisions.

3. The lid according to claim 2, wherein the fastening mechanism is the plurality of tongues that form an inner collar, the tongues being provided with spring action that will grip the outer collar when the tongues are in a relaxed state.

4. The lid according to claim 2, wherein the fastening mechanism is that the tongues are further provided with a canal for a wire that encompasses the tongues and end in a tightening mechanism for tightening the lid skirt around the sidewall.

5. The lid according to claim 4, wherein the fastening mechanism comprises a tightening wheel that winds up the wire on a spool, pressing the tongues together, thus tightening the lid skirt around the sidewall.

6. The lid according to claim 5, wherein the tightening mechanism is provided with a ratchet mechanism that is arranged to be released using a release mechanism for opening and detaching the lid.

7. The lid according to claim 4, wherein the fastening mechanism comprises a spring that tension the wire, pressing the tongues together.

8. The lid according to claim 1, wherein the lid is provided with at least one seal, for the pail further wherein the upper part of the pail further comprises:
an outer rim that is a raised extension of the sidewall, and
a downward extending part that connect to an inner rim rising up from the intervening downward extending part, wherein inner rim encloses an opening to the interior of the pail.

9. The lid according to claim 8, wherein the lid is provided with an inner seal that engages the inner rim of the pail.

10. The lid according to claim 8, wherein the lid is provided with an outer seal that engages the outer rim of the pail.

11. The lid according to claim 8, further comprising an air extractor provided on the top of the lid, extracting air from the inside of the pail through a valve.

12. The lid according to claim 1, wherein the lid is provided with at least one from the group comprising a lid handle and a stacking collar having a width adapted to receive the base of another pail.

13. A pail for a lid according to claim 1,
wherein the pail comprises:
a base forming a bottom surface of the pail,
a sidewall of the pail, wherein sidewall is further provided with an outer collar provided distal to the base, wherein the collar extends radially outward from the sidewall, and
an upper part comprising a rim extending from the sidewall.

14. The pail according to claim 13, wherein the sidewall is provided with a conical structure,
wherein the rim has an inner diameter large enough to receive the bottom surface of the pail.

15. The pail according to claim 14, wherein the outer collar is positioned on the sidewall so that when stacked on a second pail having a same structure, a rim of the second pail engages the outer collar of the pail, thus preventing the sidewalls from engaging.

16. The pail according to claim 13, further comprising a rim handle assembly provided on the rim,
wherein the rim handle assembly comprises a rim handle attached to rim handle attachments placed on the rim.

17. A thermally insulated compound pail comprising a first inner pail inserted into a second outer pail, wherein the first inner and second outer pails comprise:
a base forming the bottom surface of the pail,
a sidewall of the pail, wherein the sidewall is further provided with an outer collar provided distal to the base, wherein the collar extends radially outward from the sidewall, and
an upper part comprising a rim extending from the sidewall, wherein a space is formed between the first inner and second outer pails.

18. The thermally insulated compound pail according to claim 17, further comprising an interposer positioned between the upper parts of the first inner and second outer pails, thereby opening up a volume between the sidewalls of the pails, extending the space to this volume.

19. The thermally insulated compound pail according to claim 17, further comprising insulation in at least parts of the space.
